(19) United States
(12) Patent Application Publication
(10) Pub. No.: US 2025/0035371 A1
(43) Pub. Date: Jan. 30, 2025

(54) SYSTEM AND METHOD OF TEMPERATURE CONTROL IN AN AUTOMATED GRID BASED STORAGE AND RETRIEVAL SYSTEM

(71) Applicant: Autostore Technology AS, Nedre Vats (NO)

(72) Inventor: Espen Verpe, Haugesund (NO)

(73) Assignee: Autostore Technology AS, Nedre Vats (NO)

(21) Appl. No.: 18/715,538

(22) PCT Filed: Dec. 6, 2022
(86) PCT No.: PCT/EP2022/084553

§ 371 Date: May 31, 2024

(30) Foreign Application Priority Data
Dec. 15, 2021 (NO) 20211511

(51) Int. Cl. F25D 25/04; B65G 1/04; F25D 13/00; F25D 17/04; F25D 17/08

(52) U.S. Cl. CPC F25D 25/04; B65G 1/0464; F25D 13/00; F25D 17/045; F25D 17/08; F25D 2317/067

(57) ABSTRACT

An automated grid based storage and retrieval system includes a framework structure. The framework structure includes upright members and a grid of horizontal rails provided at upper ends of the upright members. The framework structure defines at least one storage volume below the horizontal rails. The at least one storage volume includes a plurality of storage, a plurality of walls, a first plenum, a first plurality of transversally directing air ducts, a first and second plurality of horizontally directing air ducts, and a cooling system. The plurality of storage columns are arranged adjacent one another. The plurality of walls surround an outer extent of the plurality of storage columns. The first plenum extend horizontally beneath the storage columns. The first plurality of transversally directing air ducts are connected to at least one fan adapted to draw air from outside the at least one storage volume. The first plurality of horizontally directing air ducts are positioned to distribute the air horizontally below the horizontal rails to provide a first horizontal air curtain. The cooling system is adapted to draw air from the first plenum, cool the air, and blow cooled air from an output of the cooling system as a cooled airflow. The second plurality of horizontally directing air ducts are adapted to receive the cooled airflow from the cooling system through a first air damper, the second plurality of horizontally directing air ducts being positioned at a level below the first plurality of horizontally directing air ducts to distribute at least a first portion of the cooled airflow horizontally above an uppermost layer of the storage columns.

The present invention relates to an automated storage and retrieval system for storage and retrieval of containers, in particular to a system and method of controlling an storage volume temperature in the automated storage and retrieval system.

### BACKGROUND AND PRIOR ART

FIG. 1 discloses a typical prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Referring to FIGS. 2 and 3, each prior art container handling vehicle 201,301,401 comprises a vehicle body 201a,301a,401a and first and second sets of wheels 201b, 301b,201c, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 301b, 201c, 301c, 401b,401c can be lifted and lowered, so that the first set of wheels 201b,301b,401b and/or the second set of wheels 201c, 301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal to the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2.

Conventionally, and also for the purpose of this application, Z=1 identifies the uppermost layer of storage containers, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

The cavity container handling vehicles 401 may instead have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, each rail may comprise two parallel tracks, or there may be a rail system with one track rails in one direction and two track rails in the other. A rail may also comprise two track members each having a single that have been fixed together to provide a double track rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. Note that the term ‘tilted’ means transportation of storage containers 106 having a general transportation orientation somewhere between horizontal and vertical.

In FIG. 1, the first port column 119 may for example be a drop-off port column where the container handling vehicles 201,301 can drop off storage containers 106 to be transported to an access or a transfer station, and the second port column 120 may be a dedicated pick-up port column where the container handling vehicles 201,301,401 can pick up storage containers 106 that have been transported from an access or a transfer station (not shown).

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119, 120 and the access station are located at different levels, the conveyor system may comprise a lift with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301 to a location above the storage column 105 in which the target storage container 106 is positioned, retrieving the storage container 106 from the storage column 105 using the container handling vehicle's 201,301,401 lifting device, and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 121 which typically is computerized and which typically comprises a database for keeping track of the storage containers 106.

Some of the above systems 1 may be used to store product items which require a certain environment. For example, some types of food require a chilled temperature environment (typically temperatures between −2° C. to +10° C.), some types of food require an even colder temperature environment (typically temperatures lower than-18° C.), and other types of food require a higher temperature environment (typically temperatures above 10° C.).

In buildings in which such storage systems are located, ventilation systems are typically used to provide the desired environment. However, with the space efficiency obtained by storing the containers in stacks adjacent to each other, less air is available in the storage area for the temperature control of the stored products.

In WO2016/7193419, it is disclosed a storage system where the containers are cooled during storage in a grid. The cooling system has a chiller above the grid to cool the air, and a fan circulating the cooled air through the storage system by drawing air through the system and into a vacant space under the stacks of storage containers such that the air is circulated through the stacks to regulate their temperature. The fans are positioned outside, on the side of the grid, above a bounded volume that draws air from a large number of stacks.

A problem with the prior art solution is that the chiller releases the cool air above the grid. This is particularly problematic when the required temperature environment is below 0° C. Malfunction of the container handling vehicles may occur when the cooled air is below the optimal operating temperature of the container handling vehicle. Furthermore, cooled air below 0° C. passing through the rails from above may lead to ice and/or condensation forming on the rails that may cause container handling vehicle failures such as derailing and collisions.

In view of the above it is desirable to provide an automated storage and retrieval system that solves or at least mitigates one or more of the aforementioned problems related to use of prior art storage and retrieval systems.

### SUMMARY OF THE INVENTION

The present invention is defined by the appended claims and in the following:

In a first aspect, the present invention provides an automated grid based storage and retrieval system, comprising:
a framework structure comprising upright members and a grid of horizontal rails provided at upper ends of the upright members, the framework structure defining at least one storage volume below the horizontal rails, the at least one storage volume comprising:
a plurality of storage columns arranged adjacent one another,
a plurality of walls surrounding an outer extent of the plurality of storage columns;
a first plenum extending horizontally beneath the storage columns;
a first plurality of horizontally directing air ducts connected to at least one fan adapted to draw air from outside the at least one storage volume, the first plurality of horizontally directing air ducts being positioned to distribute the air horizontally below the horizontal rails to provide a first horizontal air curtain;
a cooling system adapted to draw air from the first plenum, cool the air, and blow cooled air from an output of the cooling system as a cooled airflow; and
a second plurality of horizontally directing air ducts adapted to receive the cooled airflow from the cooling system through a first air damper, the second plurality of horizontally directing air ducts being positioned at a level below the first plurality of horizontally directing air ducts to distribute at least a first portion of the cooled airflow horizontally above an uppermost layer of the storage columns.

The first horizontal air curtain may alternatively be termed an air ceiling.

In an embodiment of the storage and retrieval system, each of the storage columns may accommodate a plurality of storage containers stacked one on top of another in vertical stacks. In embodiments wherein each of the storage columns accommodates a plurality of storage containers stacked one on top of another in vertical stacks, the first plenum may be defined as extending horizontally beneath the vertical stacks of storage containers. The first plenum may then for example be formed by a plurality of spacers fitting within a storage column, one of the spacers arranged at a bottom of each of a plurality of adjacent storage columns. The spacers may be container-shaped and comprise open sides allowing free passage of air. Suitable spacers are disclosed in e.g. WO 2021/037488 A1.

In an embodiment of the storage and retrieval system, the system comprises a heating element to heat up the air drawn from outside the storage volume before distributing the air horizontally below the horizontal rails.

In an embodiment of the storage and retrieval system, the first plenum may be configured to allow cooled air from the second plurality of horizontally directing air ducts to be drawn into the first plenum via the plurality of storage columns.

In an embodiment of the storage and retrieval system, the first plenum may be configured to allow cooled air from the second plurality of horizontally directing air ducts to be drawn into the first plenum via a plurality of ventilation apertures.

In an embodiment, the storage and retrieval system may comprise a raised floor having a plurality of ventilation holes provided between the first plenum and the plurality of storage columns or stacks of storage containers. The raised floor may be configured in any suitable manner provided air can pass between the first plenum and the storage columns. The raised floor may be configured to support the storage columns.

In an embodiment, the storage and retrieval system may comprise a second plenum extending vertically between the outer extent of the plurality of storage columns and at least one of the plurality of walls.

In an embodiment, the storage and retrieval system may comprise a plurality of downwardly directing air ducts connected to the output of the cooling system through a second air damper, the plurality of downwardly directing air ducts being positioned to distribute a second portion of the cooled airflow downwards into the second plenum.

In an embodiment, the storage and retrieval system may comprise a controller adapted to adjust the first air damper and the second air damper to control a relative distribution of the first portion of the cooled airflow and the second portion of the cooled airflow.

In an embodiment of the storage and retrieval system, the plurality of downwardly directing air ducts are arranged below the second plurality of horizontally directing air ducts.

In an embodiment of the storage and retrieval system, the plurality of vertically directing air ducts are arranged alongside the second plurality of transversally directing air ducts.

In an embodiment, the storage and retrieval system may comprise a controller (may be termed or be part of a control system) and a third air damper, the third air damper arranged between the at least one fan and the first plurality of transversally directing air ducts, the third air damper may comprise a pressure sensor, and the controller is adapted to control the speed of the at least one fan based on a predetermined pressure level.

In an embodiment, the storage and retrieval system may comprise a controller (may be termed or be part of a control system), the controller being adapted to control the air drawn from the first plenum through the cooling system such that air in the first plenum is at a lower pressure than air above the storage columns.

In an embodiment of the storage and retrieval system, the storage volume may comprise at least one temperature sensor and a controller (may be termed or be part of a control system), the controller being adapted to adjust airflow based on a temperature measured by the at least one temperature sensor.

In an embodiment of the storage and retrieval system, the controller may be configured to increase a pressure differential between the air in the first plenum and the air above the storage columns, or lower the temperature of the cooled air from the output of the cooling system, when the temperature sensor registers a temperature above a predetermined value.

In an embodiment of the storage and retrieval system, at least portions of the cooled airflow from the cooling system through the second plurality of horizontally directing air ducts may provide a second horizontal air curtain below the first horizontal air curtain.

In an embodiment of the storage and retrieval system, the cooling system may comprise a chiller to cool the air, and a fan to draw the air from the first plenum.

In an embodiment of the storage and retrieval system, the system is adapted to hold a freezing storage volume temperature in the storage volume.

In an embodiment of the storage and retrieval system, a temperature of the air being drawn from outside the storage volume may be in the range of −2° C. to +10° C.

In an embodiment of the storage and retrieval system, the air drawn from outside the storage volume may be heated to a non-freezing temperature, preferably a temperature in the range of 2-10° C., more preferably 4-6° C. In other words, the storage and retrieval system may comprise a temperature sensor and controller configured to control the heating element to heat up the air drawn from outside the storage volume to a temperature in the range of 2-10° C., more preferably 4-6° C., before distributing the air horizontally below the horizontal rails.

In an embodiment of the storage and retrieval system, the air distributed from the first plurality of horizontally directing air ducts has a temperature being more than 5° C., 10° C. or 15° C. higher than the temperature of the cooled air being distributed from the second plurality of horizontally directing air ducts.

In an embodiment, the storage and retrieval system may comprise at least one container handling vehicle for moving storage containers, the vehicle may move in two perpendicular horizontal directions upon the grid of horizontal rails and comprises a lifting device configured to retrieve a storage container from a storage column and/or store a storage container in a storage column.

In a second aspect, the present invention provides a method of controlling a storage volume temperature in the storage and retrieval system according to any embodiment of the first aspect and any embodiment of the third aspect, the method comprising the steps of:
adjusting the cooling system to blow cooled air from the output of the cooling system as the cooled airflow at a first temperature;
adjusting the first air damper to control the first portion of the cooled airflow, thereby controlling a speed of the cooled airflow through the plurality of storage columns, and controlling the storage volume temperature in the plurality of storage columns based on the first temperature and the speed of the cooled airflow through the plurality of storage columns; and
adjusting the speed of the at least one fan to draw air having a second temperature from outside the at least one storage volume, and distributing the air transversally below the horizontal rails from the first plurality of transversally directing air ducts to provide the upper, first transversal air curtain.

In an embodiment of the method, the storage and retrieval system may comprise a plurality of downwardly directing air ducts connected to the output of the cooling system through a second air damper, the plurality of downwardly directing air ducts being positioned to distribute a second portion of the cooled airflow downwards into a second plenum extending vertically between the outer extent of the plurality of storage columns and at least one of the plurality of walls, wherein the step of adjusting the first air damper to control the first portion of the cooled airflow further comprises:
adjusting the second air damper to control the relative distribution of the first portion of the cooled airflow and second portion of the cooled airflow.

In an embodiment of the method, the air drawn from outside the storage volume may be heated before being distributed horizontally below the horizontal rails. This may compensate for the vertical heat transfer in cases where the ambient air is not sufficiently warm to compensate for the vertical heat transfer and keep the tracks ice free and protect the robot from freezing temperature.

In an embodiment of the method, the air drawn from outside the storage volume may be heated to a non-freezing temperature, preferably in the range of 2-10° C., more preferably 4-6° C.

An advantage of the system is that the system creates a forced cooled airflow that isolate the cooled storage columns from the container handling vehicles on the horizontal rails and an upper, first transversal air curtain that creates a sharp boundary between temperature zones such that container handling vehicles operating on the grid of horizontal rails are not exposed to the freezing environment below, without physically separating the areas.

An advantage of the plurality of downwardly directing air ducts is to improve airflow in the system, in particular, the downwardly directing air ducts may function as an overflow system such that the cooling system may function independently of the forced cooled airflow in storage volume.

In an embodiment of the storage and retrieval system, the plurality of downwardly directing air ducts may be arranged alongside the second plurality of transversally directing air ducts.

In an embodiment of the storage and retrieval system, the system may be provided with at least two storage volumes.

In a third aspect, the present invention provides an automated grid based storage and retrieval system, comprising:
a framework structure comprising upright members and a grid of horizontal rails provided at upper ends of the upright members, the framework structure defining at least one storage volume below the horizontal rails, the at least one storage volume comprising:
a plurality of adjacent storage columns, in which storage containers are stored in stacks;
a plurality of walls surrounding an outer extent of the plurality of storage columns;
a first plenum extending horizontally beneath the stacks of storage containers;
a first plurality of horizontally directing air ducts connected to at least one fan adapted to draw air from outside the at least one storage volume, the first plurality of horizontally directing air ducts being positioned to distribute the air horizontally below the horizontal rails to provide a first horizontal air curtain;
a cooling system adapted to draw air from the first plenum, cool the air, and blow cooled air from an output of the cooling system as a cooled airflow; and
a second plurality of horizontally directing air ducts adapted to receive the cooled airflow from the cooling system through a first air damper, the second plurality of horizontally directing air ducts being positioned at a level below the first plurality of horizontally directing air ducts to distribute at least a first portion of the cooled airflow horizontally above an uppermost layer of the storage columns.

In an embodiment, the storage and retrieval system according to the third aspect comprises a plurality of spacers (or open container support frames) arranged within the storage columns, one of the spacers arranged at a bottom of each of a plurality of adjacent storage columns. The plurality of spacers defining the first plenum. Each of the spacers may be arranged to support a stack of storage containers.

The storage and retrieval system according to the third aspect may comprise any of the features of the embodiments of the storage and retrieval system according to the first aspect.

In a fourth aspect, the invention provides an automated grid based storage and retrieval system comprising a framework structure comprising upright members and a grid of horizontal rails provided at upper ends of the upright members, the framework structure defining at least one storage volume below the horizontal rails. The least one storage volume comprising a plurality of storage columns arranged adjacent one another, a plurality of walls surrounding an outer extent of the plurality storage columns, a first plenum extending beneath the storage columns, a second plenum extending vertically between the outer extent of the plurality of storage columns and the plurality of walls, first plurality of transversally directing air ducts connected to at least one fan adapted to draw air from outside the at least one storage volume, the first plurality of transversally directing air ducts being positioned to distribute the air transversally below the horizontal rails, a cooling system adapted to draw air from the first plenum, cool the air, and blow cooled air from an output of the cooling system as a cooled airflow, a second plurality of transversally directing ducts adapted to receive the cooled airflow from the cooling system through a first air damper, the second plurality of transversally directing air ducts being positioned to distribute a first portion of the cooled airflow transversally above an uppermost layer of the storage columns, a plurality of downwardly directing air ducts connected to the output of the cooling system through a second air damper, the plurality of downwardly directing air ducts adapted to distribute a second portion of the cooled air flow downwardly into the second plenum, and a controller, the controller adapted to adjust the first air damper and the second air damper to control a relative distribution of the first portion of the cooled airflow and the second portion of the cooled airflow, and the controller is further adapted to determine a speed of the at least one fan to provide an upper, first transversal air curtain.

In a fifth aspect, the invention is related to method of controlling a storage volume temperature in the automated grid based storage and retrieval system of the first aspect of the invention. The method comprises the steps of adjusting the cooling system to blow cooled air from the output of the cooling system as the cooled airflow at a first temperature; adjusting the first air damper and the second air damper to control the relative distribution of the first portion of the cooled airflow and second portion of the cooled airflow, thereby controlling a speed of the cooled airflow through the plurality of storage columns, and controlling the storage volume temperature in the plurality of storage columns based on the first temperature and the speed of the cooled airflow through the plurality of storage columns; and adjusting the speed of the at least one fan to draw air having a second temperature from outside the at least one storage volume, and distributing the air transversally below the horizontal rails from the first plurality of transversally directing air ducts to provide the upper, first transversal air curtain.

In one embodiment, the method may comprise heating up the air drawn from outside the storage volume before distributing the air transversally below the horizontal rails.

In one embodiment, the method may comprise heating up the air drawn from outside the storage volume to a non-freezing temperature, preferably in the range 2-10° C., more preferably 4-6° C.

In one embodiment, the first temperature is a freezing temperature and the second temperature is a non-freezing temperature.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of an automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view of a prior art container handling vehicle having a lifting device for carrying storage containers in an internally arranged cavity.

FIG. 5 is a schematic sideview of an exemplary automated storage and retrieval system according to an embodiment of the present invention.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

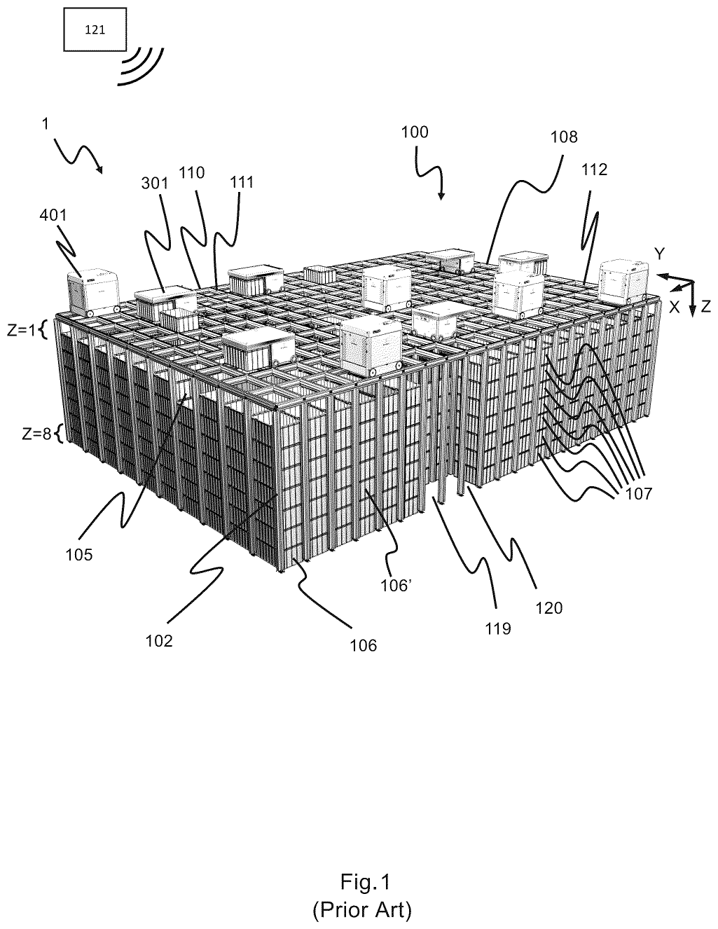

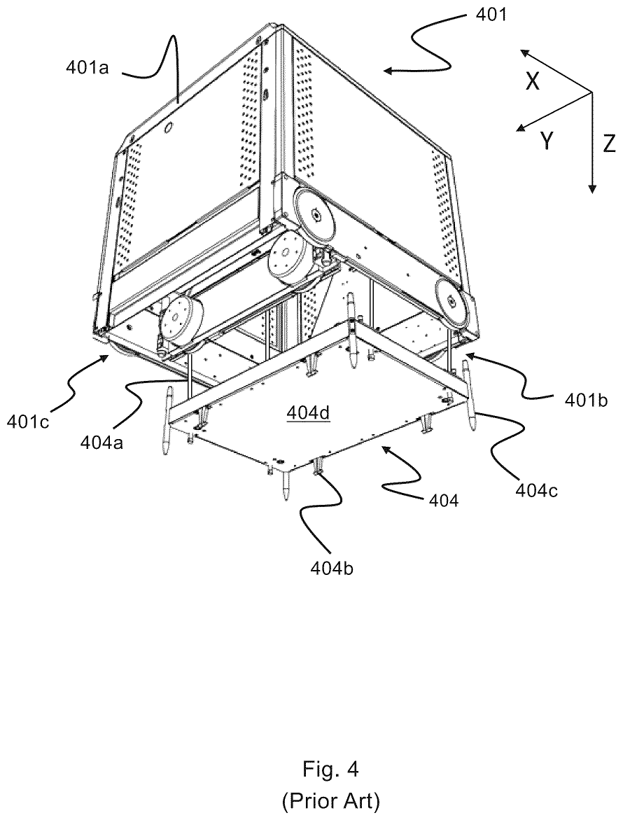

The framework structure 100 of the automated storage and retrieval system 1 is constructed in accordance with the prior art framework structure 100 described above in connection with FIGS. 1-4, i.e. a number of upright members 102, and further that the framework structure 100 comprises a first, upper rail system 108 in the X direction and Y direction.

The framework structure 100 comprises storage compartments in the form of storage columns 105 provided between the members 102, where storage containers 106 are stackable in stacks 107 within the storage columns 105.

The framework structure 100 can be of any size. In particular, it is understood that the framework structure can be considerably wider and/or longer and/or deeper than disclosed in FIG. 1. For example, the framework structure 100 may have a horizontal extent of more than 700×700 columns and a storage depth of more than twelve containers.

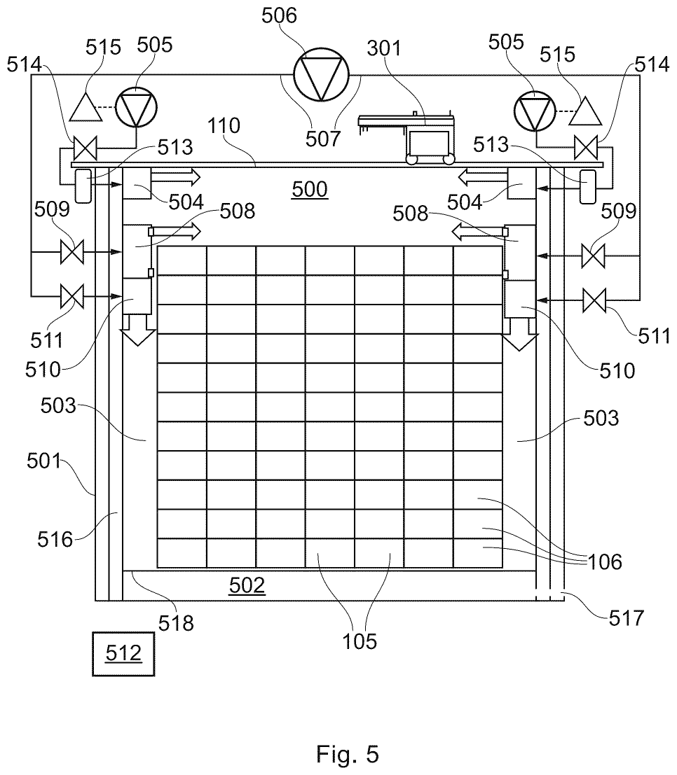

One embodiment of the automated storage and retrieval system according to the invention will now be discussed in more detail with reference to FIG. 5.

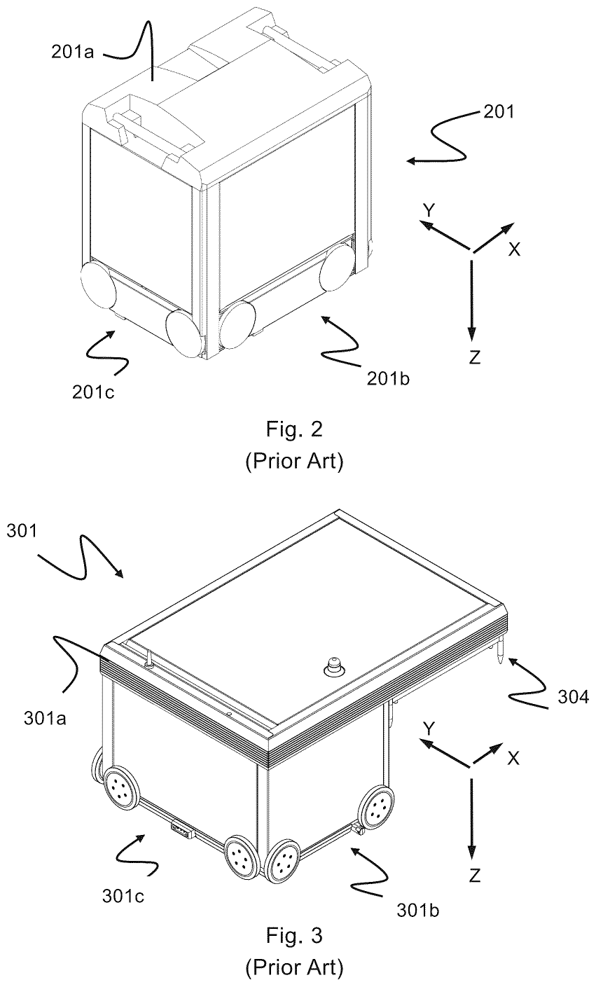

FIG. 5 is a schematic illustration of an automated storage and retrieval system, comprising a framework structure 100. The framework structure 100 defining at least one storage volume 500 comprising a plurality of storage columns 105 arranged adjacent one another below the horizontal rails 110. Storage containers 106 are stacked on top of each other within each storage column. The framework structure 100 comprises upright members 102 and a grid of horizontal rails 110 provided at upper ends of the upright members 102. To clearly illustrate the invention, the upright members 102 are not shown in the schematic illustration of FIG. 5. However, the storage columns 105 are arranged in rows in between the upright members 102 as illustrated in FIG. 1 and FIG. 2. The framework structure 100 comprises a plurality of walls 501 surrounding an outer extent of the plurality of storage columns to separate the at least one storage volume 500 from external conditions, such as temperature or/and humidity. The plurality of walls 501 surrounding the outer extent of the plurality of storage columns provides a channel extending from below the horizontal rails 110 to a first plenum or plenums 502 extending horizontally beneath the storage columns 105. The at least one storage volume 500 is open against the horizontal rails 110 such that storage container vehicles 201, 301, 401 may lower and raise storage containers 106 into and out of the storage volume 500.

As shown in FIG. 5, there is a second plenum 503 extending between the outer extent of plurality of storage columns 105 and the plurality of walls 501.

The automated storage and retrieval system comprise a first plurality of transversally directing air ducts 504 connected to at least one fan 505 adapted to draw air from outside the at least one storage volume 500. The first plurality of transversally directing air ducts 504 is being positioned to distribute the air transversally below the horizontal rails 110. This creates a sharp boundary, an upper, first transversal air curtain, between temperature zones such that neither the container handling vehicles 201, 301, 401, nor the horizontal rails 110 are exposed to the environment below. The controller 512 determines the speed of the at least one fan 505 such that the upper, first transversal air curtain keeps the horizontal rails and the container handling vehicles 201, 301, 401 at a good working temperature

In some embodiments, the temperature of the air being drawn from outside the storage volume may be in the range −2° C. to +10° C. or higher. Such an outside temperature would typically be expected when a part of the full automated storage and retrieval system is positioned within a chilled temperature environment or the system is constructed in a location where such temperatures correspond to external temperatures.

The temperature of the air being drawn from outside the storage volume may in some circumstances be too cold to hit the horizontal rails as cold air may cause unwanted condensation on the horizontal rails. Then, the system preferably, comprise a heating element 513 to heat up the air drawn from outside the storage volume before distributing the air transversally below the horizontal rails 110. The temperature of the heating element 513 may be controlled with a temperature gauge positioned between the heating element 513 and the first plurality of transversally directing air ducts 504. Approximately 5° C. is a preferred temperature of the air immediately below the horizontal rails.

The automated storage and retrieval system comprise a cooling system 506 adapted to draw air from the first plenum 502, cool the air, and blow cooled air from an output 507 of the cooling system 506 as a cooled airflow. The air may be drawn from the first plenum 502 through an opening 517 between the first plenum 502 and a cooling enclosure comprising the cooling system 506. The cooling enclosure may be arranged inside or outside the plurality of walls 501. The system comprises a second plurality of transversally directing air ducts 508 adapted to receive the cooled airflow from the cooling system 506 through a first air damper 509. The second plurality of transversal air ducts 508 is adapted to distribute a first portion of the cooled airflow transversally above an uppermost layer of the storage columns 105. This creates a lower, second transversal air curtain of cooled air, between the upper, first transversal air curtain, and the storage columns.

The cooling system 506 may in one embodiment comprise a chiller to cool the air, and a fan to draw the air from the first plenum 502. The chiller may be for example be an evaporator or a heat exchanger. The chiller may be connected to an evaporator or heat exchanger external to the storage volume 500 to dump heat outside the storage volume 500. However, any suitable cooling system may be used. The first air damper 509 may be in direct connection with the output 507 of the cooling system 506, e.g. via a conduit connecting the first air damper 509 to the output 507. In an alternative embodiment, the output 507 of the cooling system 506 may blow the cooled airflow into the cooling enclosure, and the cooled airflow is provided to the first air damper 509 by a fan drawing the cooled airflow from the cooling enclosure.

When air is drawn from the first plenum 502 through the cooling system 506 an underpressure, or vacuum, is created in the first plenum 502. The magnitude of the underpressure in the void 502 is controlled by a force drawing air into the cooler system 506 and the first portion of the cooled airflow distributed transversally above the uppermost layer of the storage columns 105 by the transversally directing air ducts 508. An overpressure is created above the of the storage columns 105 by the same second plurality of transversally directing air ducts 508. The pressure differential between the overpressure over the storage columns 105 and the underpressure in the first plenum 502, determines the speed of air through the plurality of storage columns 105. A higher pressure differential increases the speed of air and increases the cooling effect of the cooled airflow passing through the plurality of storage columns 105. A lower pressure differential reduces the speed of air and reduces the cooling effect of the cooled airflow passing through the plurality of storage columns 105. The cooled airflow through the second plurality of transversally directing air ducts 508 is determined by the first air damper 509.

For the cooling system 506 to be controlled separately from the cooled airflow passing through the plurality of storage columns 105, the at least one storage volume 500 further comprises a plurality of vertically directing air ducts 510 connected to the output 507 of the cooling system 506 through a second air damper 511. The plurality of vertically directing air ducts 510 are adapted to distribute a second portion of the cooled airflow downwards into the second plenum 503. The first air damper 509 and the second air damper 511 then help to balance the load of the cold airflow across the storage columns 105 and down the sides to provide a relatively constant load for the cooling system 506. The controller 512 is adapted to adjust the first air damper 509 and the second air damper 511 to control the relative distribution of the first portion of the cooled airflow and the second portion of the cooled airflow.

The system may comprise a third air damper 514 arranged between the at least one fan 505 and the first plurality of transversally directed air ducts 504. The third air damper 514 may comprise a pressure sensor. The controller 512 may then be adapted to control the speed of the at least one fan 505 based on a predetermined pressure level. In one embodiment, a frequency converter 515 may control the speed of the at least one fan 505 based on a pressure measured by the pressure sensor, e.g. by outputting a control voltage to the at least one fan 505 corresponding to the measured pressure.

The at least one storage volume 500 may comprise at least one temperature sensor, and the controller 112 may be adapted to adjust airflow based on a temperature measured by the at least one temperature sensor.

The system may comprise a raised floor 518 with a plurality of ventilation holes provided between the first plenum 502 and the plurality of storage columns 105. The raised floor 518 may also extend to the plurality of walls 501, such that the raised floor 518 is provided between the second plenum 503 and the first plenum 502. A total area of each of the plurality of ventilation holes may be configured to increase with the horizontal distance of each of the ventilation holes from the air intake in the first plenum 502. The total area of each of the plurality of ventilation holes may be varied by the number and/or size of ventilation holes. Small and/or few ventilation holes close to the air intake and larger and/or more ventilation holes further away from the air intake will create a more uniform airflow and more uniform cooling within the storage volume. The total area of each of the plurality of ventilation holes may be adjustable, e.g. using an aperture plate over another aperture plate where the two aperture plates are moved relative to each other. The plurality of ventilation holes may be provided by a plurality of perforations in panels forming the raised floor.

The storage volumes 500 may hold a storage volume temperature suitable for fruit, vegetables, flowers, etc., e.g. 10° C., a storage volume temperature suitable for easily perishable food such as meat, fish, dairy produce, etc., e.g. 1-4° C., or hold a freezing temperature, i.e. below 0° C., preferably −18° C. or below. There may be least two storage volumes and each storage volume may have a different storage volume temperature. In one example, there may be one storage volume at 2° C., one at 6° C., and one at 10° C. There may also be several storage volumes having similar storage volume temperatures.

In one embodiment, the plurality of walls 501 each comprise a thermal insulating material 516. A thermal insulating material is a material that has a lower thermal conductivity than general purpose construction materials, such as aluminium, acrylic glass, plywood, plaster and timber. Thermal insulating materials typically have a thermal conductivity below 0.06 Wm⁻¹K⁻¹. Exemplary thermal insulating material includes, but are not limited to, glass wool, cellulose, rock wool, polystyrene foam, urethane foam, vermiculite, perlite, and cork. The wall may be made of a thermal insulating material, the wall may be covered by an insulating material, or the thermal insulating material may be part of a sandwich wall construction. Walls 501 comprising a thermal insulating material 516 is particularly useful when the difference in storage volume temperatures between two neighboring storage volumes is too high to control by airflow only.

The storage volume temperature of the automated grid based storage and retrieval system 1 may be controlled by a method comprising the steps of:
adjusting the cooling system 506 to blow cooled air from the output 507 of the cooling system 506 as the cooled airflow at a first temperature;
adjusting the first air damper 509 and the second air damper 511 to control the relative distribution of the first portion of the cooled airflow and second portion of the cooled airflow, thereby controlling a speed of the cooled airflow through the plurality of storage columns 105, and controlling the storage volume temperature in the plurality of storage columns 105 based on the first temperature and the speed of the cooled airflow through the plurality of storage columns 105; and
adjusting the speed of the at least one fan 505 to draw air having a second temperature from outside the at least one storage volume 500, and distributing the air transversally below the horizontal rails 110 from the first plurality of transversally directing air ducts 504 to provide the upper, first transversal air curtain.

The air drawn from outside the storage volume may be heated up before distributing the air transversally below the horizontal rails 110. This would typically be the case when the outside air is too cold to hit the horizontal rails 110, as cold air may cause unwanted condensation on the horizontal rails and/or temperatures above the horizontal rails 110 outside the operating range of the container handling vehicles. The air drawn from outside the storage volume would be heated to a non-freezing temperature, preferably in the range 2-10° C., more preferably 4-6° C. Normally, the first temperature, the temperature of the cooling system 506 is a freezing temperature, while the second temperature, the temperature of the upper, first transversal air curtain, is a non-freezing temperature. When required, the air drawn from outside the storage volume may be heated to a temperature in the range of 2-10° C., and advantageously to a temperature being at least 5° C. warmer than a temperature of the cooled air providing the second transversal air curtain. Independent of whether the air drawn from outside the storage system requires heating, the temperature of the air providing the first transversal (or horizontal) air curtain is above 0° C. and at least 5° C. warmer than the cooled air providing the second transversal (or horizontal) air curtain.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Prior art automated storage and retrieval system
100 Framework structure
102 Upright members of framework structure
104 Storage grid
105 Storage column
106 Storage container
106′ Particular position of storage container
107 Stack
108 Rail system
110 Parallel rails in first direction (X)
110a First rail in first direction (X)
110b Second rail in first direction (X)
111 Parallel rail in second direction (Y)
111a First rail of second direction (Y)
111b Second rail of second direction (Y)
112 Access opening
119 First port column
120 Second port column
121 Control system
201 Prior art storage container vehicle
201a Vehicle body of the storage container vehicle 201
201b Drive means/wheel arrangement, first direction (X)
201c Drive means/wheel arrangement, second direction (Y)
301 Prior art cantilever storage container vehicle
301a Vehicle body of the storage container vehicle 301
301b Drive means in first direction (X)
301c Drive means in second direction (Y)
304 Gripping device
401 Prior art storage container vehicle
401a Vehicle body of the storage container vehicle 401
401b Drive means/wheel arrangement, first direction (X)
401c Drive means/wheel arrangement, second direction (Y)
X First direction
Y Second direction
Z Third direction
500 Storage volume
501 Wall
502 First plenum
503 Second plenum
504 1^{st} transversal air ducts
505 Fan
506 Cooling system
507 Cooling system output
508 2^{nd} transversal air ducts
509 1^{st} Air damper
510 Downwards air ducts
511 2^{nd} Air damper
521 Controller
513 Heating element
514 3^{rd} Air damper
515 Frequency converter
516 Insulation
517 Opening
518 Raised floor

1. An automated grid based storage and retrieval system, comprising:
a framework structure comprising upright members and a grid of horizontal rails provided at upper ends of the upright members, the framework structure defining at least one storage volume below the horizontal rails, the at least one storage volume comprising:
a plurality of storage columns arranged adjacent one another,
a plurality of walls surrounding an outer extent of the plurality of storage columns;
a first plenum extending horizontally beneath the storage columns;
a first plurality of transversally directing air ducts connected to at least one fan adapted to draw air from outside the at least one storage volume, the first plurality of horizontally directing air ducts being positioned to distribute the air horizontally below the horizontal rails to provide a first horizontal air curtain;
a cooling system adapted to draw air from the first plenum, cool the air, and blow cooled air from an output of the cooling system as a cooled airflow; and
a second plurality of horizontally directing air ducts adapted to receive the cooled airflow from the cooling system through a first air damper, the second plurality of horizontally directing air ducts being positioned at a level below the first plurality of horizontally directing air ducts to distribute at least a first portion of the cooled airflow horizontally above an uppermost layer of the storage columns.

2. The storage and retrieval system according to claim 1, wherein the system comprises a heating element to heat up the air drawn from outside the storage volume before distributing the air horizontally below the horizontal rails.

3. The storage and retrieval system according to claim 1, wherein the first plenum is configured to allow cooled air from the second plurality of horizontally directing air ducts to be drawn into the first plenum via the plurality of storage columns.

4. The storage and retrieval system according to claim 1, wherein the first plenum is configured to allow cooled air from the second plurality of horizontally directing air ducts to be drawn into the first plenum via a plurality of ventilation apertures.

5. The storage and retrieval system according to claim 1, comprising a raised floor having a plurality of ventilation holes provided between the first plenum and the plurality of storage columns.

6. The storage and retrieval system according to claim 1, comprising
a second plenum extending vertically between the outer extent of the plurality of storage columns and at least one of the plurality of walls.

7. The storage and retrieval system according to claim 6, comprising:
a plurality of downwardly directing air ducts connected to the output of the cooling system through a second air damper, the plurality of downwardly directing air ducts being positioned to distribute a second portion of the cooled airflow downwards into the second plenum.

8. The storage and retrieval system according to claim 7, comprising a controller adapted to adjust the first air damper and the second air damper to control a relative distribution of the first portion of the cooled airflow and the second portion of the cooled airflow.

9. The system according to claim 7, wherein the plurality of downwardly directing air ducts are arranged below the second plurality of horizontally directing air ducts.

10. The system according to any of claim 7, wherein the plurality of vertically directing air ducts are arranged alongside the second plurality of transversally directing air ducts.

11. The storage and retrieval system according to claim 1, comprising a controller and a third air damper, the third air damper arranged between the at least one fan and the first plurality of transversally directing air ducts, the third air damper comprising a pressure sensor, and the controller is adapted to control the speed of the at least one fan based on a predetermined pressure level.

12. The storage and retrieval system according to claim 1, comprising a controller, the controller being adapted to control the air drawn from the first plenum through the cooling system such that air in the first plenum is at a lower pressure than air above the storage columns.

13. The storage and retrieval system according to claim 1, wherein the storage volume comprises at least one temperature sensor and a controller, the controller being adapted to adjust airflow based on a temperature measured by the at least one temperature sensor.

14. The storage and retrieval system according to claim 12, wherein the controller is configured to increase a pressure differential between the air in the first plenum and the air above the storage columns, or lower the temperature of the cooled air from the output of the cooling system, when the temperature sensor registers a temperature above a predetermined value.

15. The storage and retrieval system according to claim 1, wherein at least portions of the cooled airflow from the cooling system through the second plurality of horizontally directing air ducts provides a second horizontal air curtain below the first horizontal air curtain.

16. The storage and retrieval system according to claim 1, wherein the cooling system comprises a chiller to cool the air, and a fan to draw the air from the first plenum.

17. The storage and retrieval system according to claim 1, wherein the system is adapted to hold a freezing storage volume temperature in the storage volume.

18. The storage and retrieval system according to claim 1, wherein a temperature of the air being drawn from outside the storage volume is in the range of −2° C. to +10° C.

19. A method of controlling a storage volume temperature in the storage and retrieval system comprising:
a framework structure comprising upright members and a grid of horizontal rails provided at upper ends of the upright members, the framework structure defining at least one storage volume below the horizontal rails, the at least one storage volume comprising:
a plurality of storage columns arranged adjacent one another,
a plurality of walls surrounding an outer extent of the plurality of storage columns;
a first plenum extending horizontally beneath the storage columns;
a first plurality of transversally directing air ducts connected to at least one fan adapted to draw air from outside the at least one storage volume, the first plurality of horizontally directing air ducts being positioned to distribute the air horizontally below the horizontal rails to provide a first horizontal air curtain;
a cooling system adapted to draw air from the first plenum, cool the air, and blow cooled air from an output of the cooling system as a cooled airflow; and
a second plurality of horizontally directing air ducts adapted to receive the cooled airflow from the cooling system through a first air damper, the second plurality of horizontally directing air ducts being positioned at a level below the first plurality of horizontally directing air ducts to distribute at least a first portion of the cooled airflow horizontally above an uppermost layer of the storage columns,
the method comprising:
adjusting the cooling system to blow cooled air from the output of the cooling system as the cooled airflow at a first temperature;
adjusting the first air damper to control the first portion of the cooled airflow, thereby controlling a speed of the cooled airflow through the plurality of storage columns, and controlling the storage volume temperature in the plurality of storage columns based on the first temperature and the speed of the cooled airflow through the plurality of storage columns; and
adjusting the speed of the at least one fan to draw air having a second temperature from outside the at least one storage volume, and distributing the air transversally below the horizontal rails from the first plurality of transversally directing air ducts to provide the upper, first transversal air curtain.

20. The method according to claim 20, wherein the storage and retrieval system comprises a plurality of downwardly directing air ducts connected to the output of the cooling system through a second air damper, the plurality of downwardly directing air ducts being positioned to distribute a second portion of the cooled airflow downwards into a second plenum extending vertically between the outer extent of the plurality of storage columns and at least one of the plurality of walls, wherein the adjusting of the first air damper to control the first portion of the cooled airflow further comprises:
adjusting the second air damper to control the relative distribution of the first portion of the cooled airflow and second portion of the cooled airflow.

21. The method according to claim 19, wherein the air drawn from outside the storage volume is heated before being distributed horizontally below the horizontal rails.

22. The method according to claim 21, wherein the air drawn from outside the storage volume is heated to a non-freezing temperature, preferably in the range of 2-10° C.
